(19) United States
(12) Patent Application Publication
(10) Pub. No.: US 2014/0019427 A1
(43) Pub. Date: Jan. 16, 2014

(54) FRAMEWORK FOR CONTEXT-AWARE SYSTEMS AND METHODS

(71) Applicants: Kaiyu Wan, Shanghai (CN); Vangalur Alagar, Laval (CA); Mubarak Mohammad, Laval (CA)

(72) Inventors: Kaiyu Wan, Shanghai (CN); Vangalur Alagar, Laval (CA); Mubarak Mohammad, Laval (CA)

(73) Assignee: C.T. CONSULTANTS INC., Laval, QC (CA)

(21) Appl. No.: 14/005,480

(22) PCT Filed: Apr. 2, 2012
(86) PCT No.: PCT/CA2012/000289

§ 371 Date: Oct. 1, 2013

Related U.S. Application Data
(60) Provisional application No. 61/470,147, filed on Mar. 31, 2011.

(51) Int. Cl. G06F 17/30

(52) U.S. Cl. CPC G06F 17/30312
USPC 707/694

(57) ABSTRACT

The present document describes a context aware system (CAS) for automatically controlling a plurality of actuators based on fact information received from a plurality of detectors, wherein the actuators and detectors may be added and removed in a plug and play manner. The CAS comprises a sensor mechanism for sensing parameter of an environment and outputting fact information relating to the parameters. A context mechanism extracts context from the fact information and generates situations using a set of situation definitions and context definitions. The context mechanism may include one or more reasoners that work independently in a separation of concern manner to output situations pertaining to different domains. The situations are sent to an adaptation mechanism for determining one or more actions for each situation. Each action is sent to an actuator for execution.

### CROSS-REFERENCE TO RELATED APPLICATIONS

This application claims priority of U.S. provisional patent application No. 61470147 filed on Mar. 31, 2011 which is hereby incorporated by reference in its entirety.

### BACKGROUND

(a) Field

The subject matter disclosed generally relates to context aware systems and methods.

(b) Related Prior Art

Context helps us better comprehend the surrounding environment of a specific situation. It exists in our everyday activities. For example, in conversations, humans have the ability to go back and forth between different topics that may seem irrelevant to an observer who lacks knowledge of the context of the conversation while it sounds perfectly normal to someone who is aware of the context. Unfortunately, this does not translate optimally in Human Computer Interaction (HCl). It is challenging to capture context with computers due to technology constrains.

When a person asks a friend about a restaurant, the friend may respond with good answers keeping in mind the preferences of the requester such as quality of service, price and ambience. Hence, the answer provided is relevant. On the other hand, the same query when presented to a search engine would give various results that may or may not match the requester preferences. Enhancing the relevance of the results can be a tedious task without explicitly specifying the preferences which are mostly subjective in nature.

Context-aware systems (CAS) are the class of computing systems which maintain continuous monitoring of the surrounding environment and adapt their operations based on the changes in current context without direct user intervention.

Context information is captured using what is called “sensors”. Sensors can be broadly defined as entities that provide measurable responses to changes in an application's environment. CAS are required to interact with sensors. Sensors can be hardware devices such as GPS sensor or software applications such as authorization providers.

Adapting to the constantly changing context is equally challenging as perceiving context. Adaptation requires accurately mapping predefined actions to specific context situations. Moreover, it requires dynamic composition of these actions which underlines the importance of having a flexible yet formal definition of adaptation. Predefined actions are implemented using actuators. Actuators represent the parts of a computing system which perform actions at the last stage. Just like sensors, actuators could be software based such as database transactions or hardware devices such as door controllers. Context-aware applications need a mechanism to interact with actuators.

Existing context-aware systems are generally heterogeneous, complex, and one-dimensional. Heterogeneity often results from the variety of sensory devices used to perceive the environment of concern, diversity of context information and adaptations, and the multiplicity of actuators provided to adapt to environmental situations. Complexity results from the diversity of relations and connections between devices, context construction and interpretation, and the dynamic nature of the environment where contexts change requiring new devices to be added and some old ones to be discarded. Single dimensionality comes from the fact that existing CAS are designed to operate in a specific domain and may not be used to perform other functions in other domains. For example, CAS used in healthcare may not be used in transportation, defense, agriculture, etc.

Another problem associated with Existing CAS is that the adaptations are based on the sensor outputs. However, sensor outputs are not always accurate and their trustworthiness varies in respect to other environment aspects. For example, GPS data accuracy is related to the number of available satellites, weather information and whether the receiver is placed indoor or outdoor. Another example, card readers do not always reflect the identity/location of a card owner because the card may be copied and/or used by another person with or without the card owner's knowledge.

Therefore, there is a need for a context aware framework which addresses the shortfalls of existing CAS discussed above.

### SUMMARY

Embodiments of the invention describe a universal framework for building CAS that operate in different and unrelated domains, wherein sensors and actuators may be added and removed to the CAS in a plug and play manner.

According to an embodiment, there is provided a context aware system for automatically controlling a plurality of actuators based on fact information received from a plurality of detectors, the system comprising:
a data store for storing a set of rules and definitions;
a context mechanism including at least one reasoner for receiving the fact information from the plurality of detectors and transforming the fact information into situations based on a context of the fact information and situation definitions stored in the data store; and
an adaptation mechanism for determining one or more reactions for at least one situation and sending each reaction to a corresponding actuator for execution;
   wherein detectors and actuators are added to and removed from the system in a plug and play manner.

According to an aspect, the context mechanism further comprises a context builder configured to receive the fact information and to transform it into context using a set of context definitions stored in the data store.

According to an aspect, the context mechanism further comprises one or more context translators configured to translate the context into different formats that are compatible with different types of reasoners.

According to an aspect, the context mechanism further comprises a plurality of reasoners configured to output situations pertaining to different dimensions/domains, each reasoner being configured to operate independently on at least a portion of the fact information.

According to an aspect, the different types of reasoners include rule-based reasoners, logic-based reasoners, inference-based reasoners, and ontology-based reasoners.

According to an aspect, the at least one reasoner is configured for receiving the fact information which includes an identification of a context dimension/domain and a tag value.

According to an aspect, the system further includes a data aggregator configured to aggregate the fact information from the plurality of detectors, and update the fact information from the latest detector readings.

According to an aspect, the data aggregator is configured to apply a set of predefined rules to contradicting and/or conflicting fact information relating to the same fact and originating from multiple detectors to provide the context mechanism with the most relevant fact information.

According to an aspect, the data aggregator is configured to apply a set of predefined policies/rules to filter out fact information that violates one or more of the set of predefined policies/rules.

According to an aspect, the data aggregator is configured to notify the context mechanism of any change in fact information for determining and executing appropriate reactions in real time.

According to an aspect, the data store is an asynchronous data store.

According to an aspect, the data store is a synchronous data store.

According to an aspect, the data store is accessible by a user for modification of the set of rules and definitions for receiving additional detectors and actuators in a plug and play manner.

According to another embodiment, there is provided a non-transitory computer readable medium having recorded thereon one or more programs for execution by a processor for implementing the context aware system described above.

According to another embodiment, there is provided a context aware system comprising:
an asynchronous data store for storing a set of rules and definitions;
a sensor mechanism comprising a plurality of detectors for detecting one or more parameters in an environment and outputting fact information relating to the one or more parameters;
a context mechanism including at least one reasoner for receiving the fact information from the plurality of detectors and transforming the fact information into situations based on a context of the fact information and situation definitions stored in the data store;
an adaptation mechanism for determining one or more reactions for at least one situation using a set of adaptation definitions stored in the data store;
a reactivity mechanism including a plurality of actuators for executing the one or more reactions;
   wherein detectors and actuators are added to and removed from the system in a plug and play manner.

According to an aspect, the system further comprises:
one or more context translators configured to translate the context into different formats that are compatible with different types of reasoners; and
a plurality of reasoners configured to output situations pertaining to different dimensions/domains, each reasoner being configured to operate independently on at least a portion of the fact information.

According to another embodiment, there is provided a context mechanism for receiving fact information from a plurality of detectors and transforming the fact information into situations for use by an adaptation mechanism, the context mechanism having access to a data store including a list of rules and definitions, the context mechanism comprising:
a context builder configured to receive the fact information and to transform it into context using a set of context definitions stored in the data store;
a context translator configured to translate the context into different formats that are compatible with different types of reasoners;
a plurality of reasoners configured to output situations pertaining to different dimensions/domains, each reasoner being configured to operate independently on at least a portion of the fact information.

According to another embodiment, there is provided a non-transitory computer readable medium having recorded thereon one or more programs for execution by a processor for implementing the context mechanism described above.

According to another embodiment, there is provided a method for automatically controlling a plurality of actuators in a Context Aware System, the method comprising:
receiving fact information from a plurality of detectors;
extracting context from the fact information using a set of context definitions;
detecting one or more situations based on the context and a set of situation definitions;
selecting one or more reactions for at least one situation using a set of adaptation definitions and policy definitions; and
sending each reaction to an actuator for execution.

According to an aspect, the method further comprises receiving the context definitions, situation definitions and policy definitions from a user and storing these in a data store.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a block diagram illustrating an example of a framework architecture for a context-aware system (CAS);

FIG. 2 is a detailed view illustrating the major components of the framework of FIG. 1;

FIG. 3 illustrates an embodiment of a context mechanism including different types of reasoners;

FIG. 4 is a flowchart of a method for automatically controlling a plurality of actuators in a Context Aware System; and

FIG. 5 illustrates an embodiment of a computing environment in which embodiments of the present invention may be practiced.

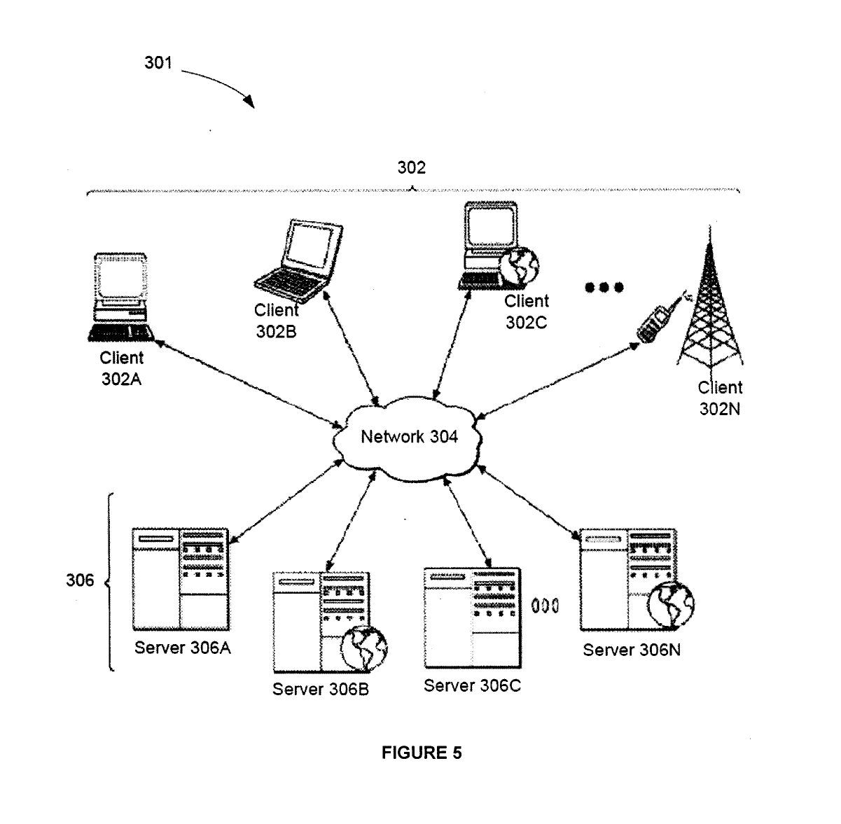

It will be noted that throughout the appended drawings, like features are identified by like reference numerals.

### DETAILED DESCRIPTION

In embodiments there is disclosed a context aware system (CAS) for automatically controlling a plurality of actuators based on fact information received from a plurality of detectors, wherein the actuators and detectors may be added and removed in a plug and play manner. The CAS comprises a sensor mechanism for sensing parameter of an environment and outputting fact information relating to the parameters. A context mechanism extracts context from the fact information and generates situations using a set of situation definitions and context definitions. The context mechanism may include one or more reasoners that work independently in a separation of concern manner to output situations pertaining to different domains. The situations are sent to an adaptation mechanism for determining one or more actions for each situation. Each action is sent to an actuator for execution.

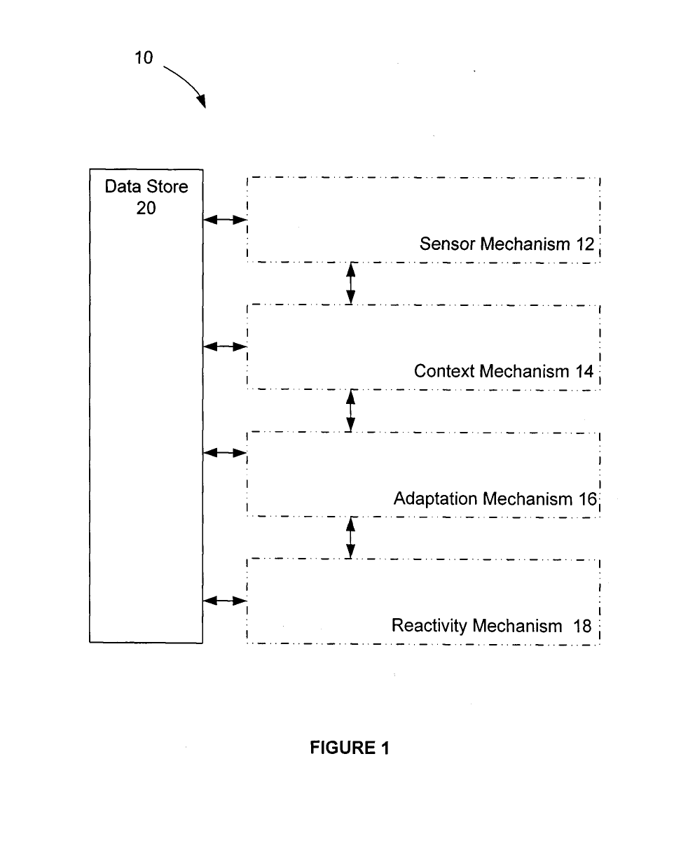

FIG. 1 is a block diagram illustrating an example of a framework architecture for a context-aware system (CAS), in accordance with an embodiment. As illustrated in FIG. 1, the context aware framework 10 comprises a sensor mechanism 12, a context mechanism 14, an adaptation mechanism 16, a reactivity mechanism 18, and a data store 20 for storing a set of rules and definitions. Preferably, the data store may be asynchronous for permitting access to and storage of information by the different mechanisms at different times. However, the embodiments may also employ a synchronous data store.

In general terms, the sensor mechanism 12 may be responsible for monitoring the environmental entities and sensing any changes to their parameters, dimensions that are of interest to the system. The parameters are scalar or structured data values such as temperature, geographical position, and identity of a person. The context mechanism 14 may be responsible for context construction, context modification, and context reasoning. It relates the data received from the sensor mechanism to events of significance to build awareness. This in turn will assist the system to perform the appropriate adaptation. The adaptation mechanism 16 may be responsible for analyzing the collected knowledge about the environment and triggering the appropriate reactions (zero reactions, one reaction, or more than one reactions). In the proposed architecture the analysis is based on predefined rules and policies, which are stored in a shared database. The resulting reactions are regulated by policies. The reactivity mechanism 18 is responsible for performing the reactions and adaptations in the environment by controlling physical devices, actuators, or displaying results on hardware interfaces. For example, raising or lowering the temperature by adjusting the thermostats controller in a room is a possible reaction to the event “person entering a room”.

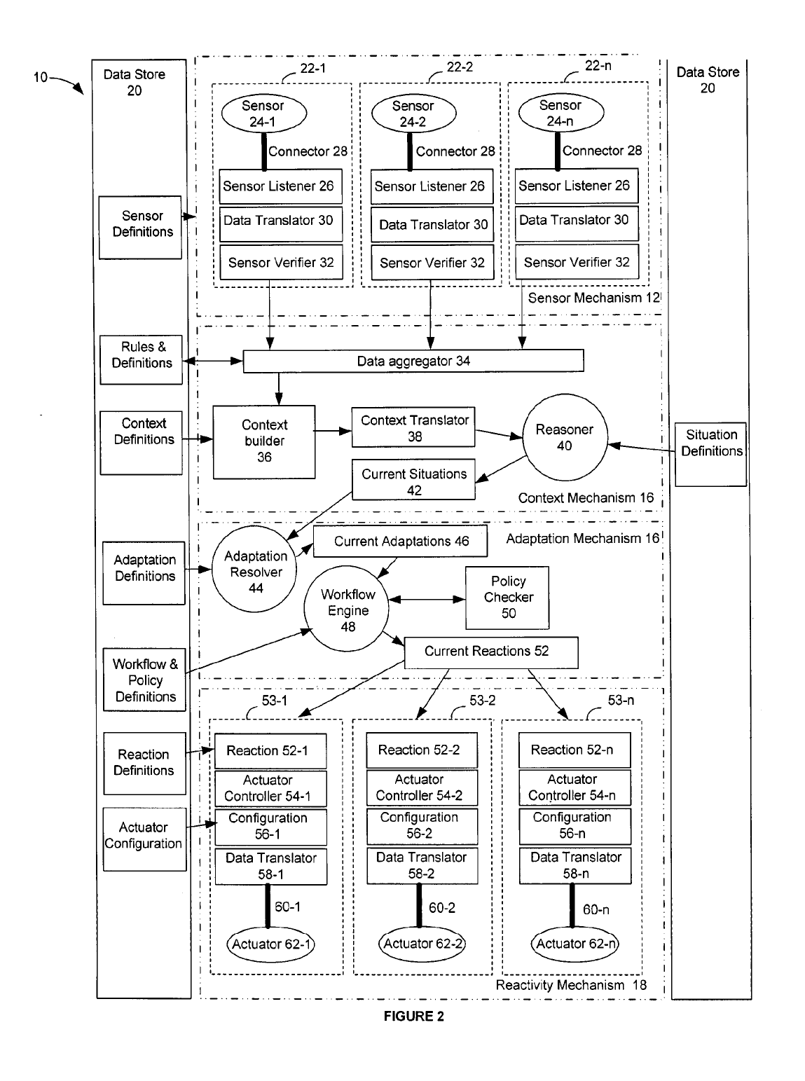

FIG. 2 is a detailed view illustrating the major components of the framework 10. As shown in FIG. 2, the sensor mechanism 12 comprises a plurality of sensor modules 22, each comprising a sensor 24 e.g. temperature sensor, a sensor listener 26 for receiving and recording the data captured by the sensor 24, a connector 28 for connecting between the sensor 24 and the sensor listener 26, a data translator 30 for performing the necessary data conversion and a sensor verifier 32 for verifying the data. In an embodiment, the sensor mechanism 12 may have access to the data store 20 for obtaining sensor definitions for the different sensors 24-1 to 24-n to identify the sensors, their functions, locations etc.

While the components of the sensor modules 22 are shown as being part of the same module, it is to be understood that one or more of these components may be located at different places especially when the connector 28 includes a wireless connection such as Wi-Fi, Bluetooth, or the like. For example, the sensor may be provided at the door while the sensor listener 26 and the remaining components are in the server room. It is also to be noted that the sensors 24 may include different types of sensors that sense the same or different aspects of the surrounding environment, and thus, the sensor listeners 26, data translators 30, and sensor verifiers 32 may also be different depending on the sensors 24 and the type of data captured by these.

The different sensor modules 22 of the sensor mechanism send their data (fact information) to the context mechanism 14. The data is received at a data aggregator 34. The data aggregator 34 is adapted to update the fact information with the latest sensor readings obtained from the sensor modules 22. The data aggregator 34 may also have access to a set of rules and definitions stored in the data store 20 to apply these rules and definitions to the data received from the different sensor modules 22 prior to outputting this data to the following components of the context mechanism. In a non-limiting example of implementation, the data aggregator 34 may apply a set of rules that enables the data aggregator 34 to choose the highest possible fact information when the data aggregator receives contradicting fact information from different sensor modules. In one example, the data aggregator may give higher priority/value to certain sensor modules over others.

For example, consider a scenario where different sensor modules are implemented in a building to identify the location of each individual within the building. Assuming that the different sensor modules include biometric sensor modules which identify a person based on the voice, fingerprint, retina etc. and electronic detectors which detect the identity of the person based on an access code, card reader or the like. If the biometric sensor modules indicates that the a certain person is in room A because his voice has been or is being detected in that room, and the electronic detectors indicate that the same person is in room B because his access code or magnetic card has been used in that room, then priority is given to the biometric data because it is possible to use someone else's card or access code but it is not possible to use their voice or fingerprint. In this case, the data aggregator 34 may output the location as being in room A.

It is to be noted that the set of rules may be set, adjusted, and changed by the user as the needs dictate. For example, the same scenario may lead to different results if the set of rules accounts for the recency of the information. For example, if the data output by the biometric sensors indicates that the person is in room A and the timestamp of that data is 12.54 PM, while the data output by the electronic sensors indicate that the same person is in room B and the data has a timestamp of 1.05 PM then, even if the biometric sensors have the higher priority over electronic sensors, the recency of the information from the electronic sensors may provide for more accurate results because it would have been possible for the person to have left room A and entered room B.

The data aggregator 34 outputs verified and updated fact information to the context builder 36. The context builder 36 has access to a set of context definitions stored in the data store 20, in order to build context based on the fact information received from the data aggregator 34. Since the environment constantly changes, the context builder 36 may rebuild context every time there is a change in the fact information. Information about new changes may come from the sensor mechanism 12. In an embodiment, the sensor mechanism 12 may trigger the context builder 36 to rebuild context every time a new sensor reading is detected.

The context built by the context builder 36 may then be sent to the context translator 38 to translate the context to a language that the reasoner engine 40 may understand. The reasoner 40 may have access to a set of situation definitions stored in the data store 20 for identifying one or more situations 42 based on the context received from the context builder 36.

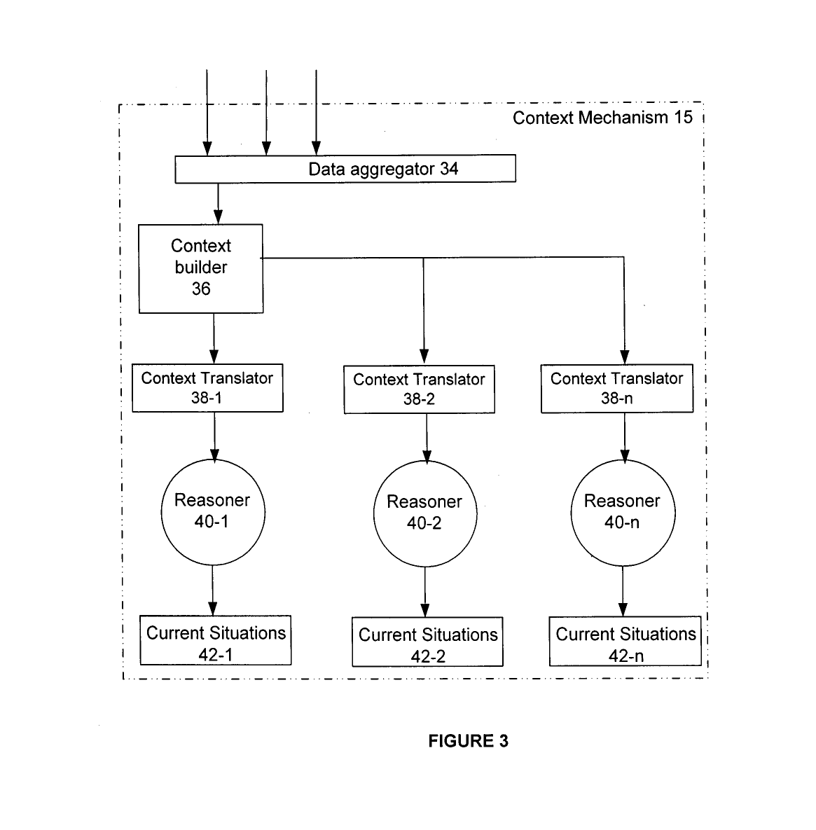

In an embodiment, it is possible to use a plurality of reasoner engines 40 of different (or similar) types. FIG. 3 illustrates an embodiment of a context mechanism 15 including different types of reasoners 40. Each reasoner 40 may have a context translator 38 associated therewith whereby the reasoners may work independently, separately (in a separation of concern manner) and simultaneously using at least a portion of the context generated by the context builder 36.

As stated above, the reasoners may operate in a separation of concern, and the set of rules and definitions may be set, changed, and adjusted by the user, whereby, sensors (aka detectors) and actuators may be added and removed in a plug and play manner, and the platform may be used in a variety of different and unrelated domains.

The current situations 42 are sent to the adaptation mechanism for generating reactions for the situations identified by the context mechanism. In an embodiment, the current situations are received at an adaptation resolver 44. The adaptation resolver 44 may have access to a set of adaptation definitions stored in the data store 20 for generating current adaptations 46. By knowing the situation, the adaptation resolver searches the set of adaptations and selects the adaptation 46 that is related to the current situation 42. The adaptations 46 may then be sent to a workflow engine 48. The workflow engine 48 may have access to a set of workflow and policy definitions stored in the data store 20 as well as a policy checker 50 adapted to evaluate policies and control execution of reactions. The policy checker 50 takes as input a situation 42 and a policy condition. It evaluates the condition using the context information available in the situation definition. The result controls whether or not an action should be triggered.

In an embodiment, associations between situations and adaptations are defined and managed in the data store. A situation can have one or more possible adaptations. By knowing the situation, the adaptation resolver 44 searches the set of adaptations and selects the adaptation that is related to the current situation. An adaptation defines a set of reactions to be produced and the order in which the reactions should be executed. Also, the adaptation expression defines execution controls over the set of reactions. Execution policies are used as conditions to control reactions. The workflow engine 48 is an engine that is used to execute workflows. It contains implementations for every construct in the workflow expression language and takes as input a situation and an adaptation. Then, it uses the policy checker 50 to evaluate policies and control execution of reactions. As discussed above the policy checker 50 determines whether or not an action should be triggered.

If one or more actions 52 (aka reactions) are to be triggered, the current reactions 52 may be sent to the reactivity mechanism 18 to be executed by a single reaction module 53. In an embodiment, the reactions are atomic system actions that may not be split any further. Reactions may have the following properties:
Independence: A reaction may be executed with no dependency on any other reaction.
Atomicity: A reaction may be atomic, and performs one and only one functionality.
Communication: A reaction may communicate with the outside world actors, namely the actuators.
Context dependence: A reaction may have execution parameters which depend on context information. These parameters are passed to actuators. For example, if an action aims to display a message on a screen then the message should be passed from the reaction to the screen actuator.

In an embodiment each reaction module 53 may include an actuator controller 54, an actuator configuration 56, a data translator 58, a connector 60, and an actuator 62. Once reactions 52 are decided, their corresponding actuators 62/actuator controllers 54 are determined. Associations between reactions and actuators are defined and managed in the data store. It is possible to associate multiple actuators with each reaction 52. For each actuator 62 an actuator controller 54 is defined. The actuator controller 54 provides a level of abstraction between the system and the actuators 62. Each actuator controller 54 is implemented for a specific actuator 62. A controller 62 may have sufficient knowledge to communicate to its corresponding actuator 62. The actuator configuration 56 is used to specify any necessary configuration for an actuator. Configurations are abstracted from actuator controllers 54. This allows for using the same actuator 62 to implement different workflow actions based on different configurations. For example, the door actuator can perform open, close, lock and unlock actions through different configurations. A connector 60 is used to transmit an adaptation reaction and its relevant context information to actuators 62. It implements a connection method and a communication protocol. A data translator 58 is used to translate the command and its information into a format suitable for actuators 62. A data translator 58 is implemented for each type of actuators 62.

Actuators perform the actions to affect the environment. There are many different types of actuators. An actuator type is characterized by a set of attributes and data parameters that represent the required input information necessary for performing actions.

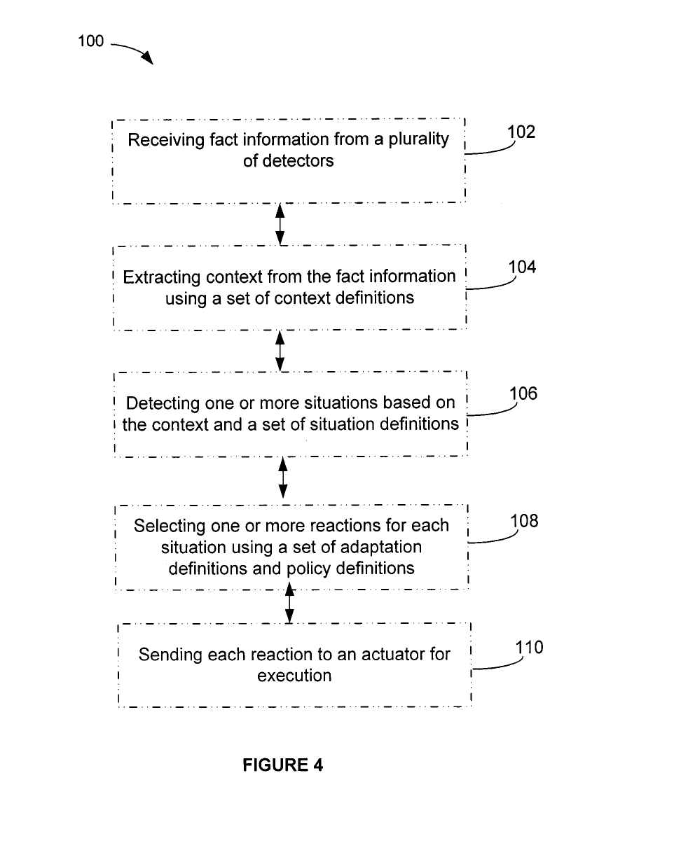

FIG. 4 is a flowchart of a method for automatically controlling a plurality of actuators in a Context Aware System. At step 102 the method comprises receiving fact information from a plurality of detectors. Step 104 comprises extracting context from the fact information using a set of context definitions. Step 106 comprises detecting one or more situations based on the context and a set of situation definitions. Step 108 comprises selecting one or more reactions for each situation using a set of adaptation definitions and policy definitions. Step 110 comprises sending each reaction to an actuator for execution.

### Hardware and Operating Environment

Embodiments of the invention may be implemented/operated using a client machine. The client machine may in some embodiments be embodied in any one of the following computing devices: a computing workstation; a desktop computer; a tablet, a laptop or notebook computer; a server; a handheld computer; a mobile telephone; a portable telecommunication device; a media playing device; a gaming system; a mobile computing device; a device of the IPOD or IPAD family of devices manufactured by Apple Computer; any one of the PLAYSTATION family of devices manufactured by the Sony Corporation; any one of the Nintendo family of devices manufactured by Nintendo Co; any one of the XBOX family of devices manufactured by the Microsoft Corporation; or any other type and/or form of computing, telecommunications or media device that is capable of communication and that has sufficient processor power and memory capacity to perform the methods and systems described herein. In other embodiments the client machine can be a mobile device such as any one of the following mobile devices: a JAVA-enabled cellular telephone or personal digital assistant (PDA), such as the i55sr, i58sr, i85s, i88s, i90c, i95cl, or the im1100, all of which are manufactured by Motorola Corp; the 6035 or the 7135, manufactured by Kyocera; the i300 or 1330, manufactured by Samsung Electronics Co., Ltd; the TREO 180, 270, 600, 650, 680, 700p, 700w, or 750 smart phone manufactured by Palm, Inc; any computing device that has different processors, operating systems, and input devices consistent with the device; or any other mobile computing device capable of performing the methods and systems described herein.

Still other embodiments of the client machine include a mobile client machine that can be any one of the following: any one series of Blackberry, Playbook or other handheld device manufactured by Research In Motion Limited; the iPhone manufactured by Apple Computer; Windows Phone 7, HTC, Sony Ericsson, any telephone or computing device running the Android operating system, or any handheld or smart phone; a Pocket PC; a Pocket PC Phone; or any other handheld mobile device supporting Microsoft Windows Mobile Software, etc.

The client machine may include a display and a touch-sensitive surface. It should be understood, however, that the computing device may also include one or more other physical user interface devices, such as a physical keyboard, a mouse and/ or a joystick.

FIG. 9 illustrates an example of a computing environment 301 that includes one or more client machines 302A-302N in communication with servers 306A-306N, and a network 304 installed in between the client machines 302A-302N and the servers 306A-306N. In some embodiments, client machines 302A-302N may be referred to as a single client machine 302 or a single group of client machines 302, while servers may be referred to as a single server 306 or a single group of servers 306. One embodiment includes a single client machine 302 communicating with more than one server 306. Another embodiment includes a single server 306 communicating with more than one client machine 302, while another embodiment includes a single client machine 302 communicating with a single server 306.

The client machine 302 may in some embodiments execute, operate or otherwise provide an application that can be any one of the following: software; a program; executable instructions; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other type and/or form of executable instructions capable of executing on client machine 302. Still other embodiments may include a computing environment 301 with an application that is any of either server-based or remote-based, and an application that is executed on the server 306 on behalf of the client machine 302. The client machine 302 may include a network interface to interface to a Local Area Network (LAN), Wide Area Network (WAN) or the Internet through a variety of connections including, but not limited to, standard telephone lines, LAN or WAN links (e.g., 802.11, T1,T3, 56 kb, X.25, SNA, DECNET), broadband connections (e.g., ISDN, Frame Relay, ATM, Gigabit Ethernet, Ethernet-over-SONET), wireless connections, or some combination of any or all of the above.

The computing environment 301 can in some embodiments include a server 306 or more than one server 306 configured to provide the functionality of any one of the following server types: a file server; an application server; a web server; a proxy server; an appliance; a network appliance; a gateway; an application gateway; a gateway server; a virtualization server; a deployment server; a SSL VPN server; a firewall; a web server; an application server or as a master application server; a server 306 configured to operate as an active direction; a server 306 configured to operate as application acceleration application that provides firewall functionality, application functionality, or load balancing functionality, or other type of computing machine configured to operate as a server 306. In some embodiments, a server 306 may include a remote authentication dial-in user service such that the server 306 is a RADIUS server.

The network 304 between the client machine 302 and the server 306 is a connection over which data is transferred between the client machine 302 and the server 306. Although the illustration in FIG. 9 depicts a network 304 connecting the client machines 302 to the servers 306, other embodiments include a computing environment 301 with client machines 302 installed on the same network as the servers 306. Other embodiments can include a computing environment 301 with a network 304 that can be any of the following: a local-area network (LAN); a metropolitan area network (MAN); a wide area network (WAN); a primary network comprised of multiple sub-networks located between the client machines 302 and the servers 306; a primary public network with a private sub-network; a primary private network with a public sub-network; or a primary private network with a private sub-network. Still further embodiments include a network 304 that can be any of the following network types: a point to point network; a broadcast network; a telecommunications network; a data communication network; a computer network; an ATM (Asynchronous Transfer Mode) network; a SONET (Synchronous Optical Network) network; a SDH (Synchronous Digital Hierarchy) network; a wireless network; a wireline network; a network 304 that includes a wireless link where the wireless link can be an infrared channel or satellite band; or any other network type able to transfer data from client machines 302 to servers 306 and vice versa to accomplish the methods and systems described herein. Network topology may differ within different embodiments, possible network topologies include: a bus network topology; a star network topology; a ring network topology; a repeater-based network topology; a tiered-star network topology; or any other network topology able transfer data from client machines 302 to servers 306, and vice versa, to accomplish the methods and systems described herein. Additional embodiments may include a network 304 of mobile telephone networks that use a protocol to communicate among mobile devices, where the protocol can be any one of the following: AMPS; TDMA; CDMA; GSM; GPRS UMTS; or any other protocol able to transmit data among mobile devices to accomplish the systems and methods described herein.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A context aware system for automatically controlling a plurality of actuators based on fact information received from a plurality of detectors, the system comprising:
a data store comprising a set of rules and definitions for interpreting the fact information received from the detectors;
a context mechanism including at least one reasoner for receiving the fact information from the plurality of detectors and transforming the fact information into situations based on a context of the fact information and situation definitions stored in the data store; and
an adaptation mechanism for determining one or more reactions for at least one situation and sending each reaction to a corresponding actuator for execution;
wherein detectors and actuators are added to and removed from the system in a plug and play manner.

2. The system of claim 1, wherein the context mechanism further comprises a context builder configured to receive the fact information and to transform it into context using a set of context definitions stored in the data store and to output the context to the at least one reasoner.

3. The system of claim 2, wherein the context mechanism further comprises one or more context translators configured to translate the context into different formats that are compatible with different types of reasoners.

4. The system of claim 3, wherein the context mechanism further comprises a plurality of reasoners configured to receive the context from the context translators and output situations pertaining to different dimensions/domains, each reasoner being configured to operate independently on at least a portion of the fact information, wherein reasoners are added to and removed from the system in a plug and play manner.

5. The system of claim 4, wherein the different types of reasoners include rule-based reasoners, logic-based reasoners, inference-based reasoners, and ontology-based reasoners.

6. The system of claim 1, wherein the at least one reasoner is configured for receiving the fact information which includes an identification of a context dimension/domain and a tag value.

7. The system of claim 1, further including a data aggregator configured to aggregate the fact information from the plurality of detectors, and update the fact information from the latest detector readings.

8. The system of claim 7, wherein the data aggregator is configured to apply a set of predefined rules to contradicting and/or conflicting fact information relating to the same fact and originating from multiple detectors to provide the context mechanism with the most relevant fact information.

9. The system of claim 7, wherein the data aggregator is configured to apply a set of predefined policies/rules to filter out fact information that violates one or more of the set of predefined policies/rules.

10. The system of claim 7, wherein the data aggregator is configured to notify the context mechanism of any change in fact information for determining and executing appropriate reactions in real time.

11. The system of claim 1, wherein the data store is an asynchronous data store.

12. The system of claim 1, wherein the data store is a synchronous data store.

13. The system of claim 1, wherein the data store is accessible by a user for modification of the set of rules and definitions for receiving additional detectors and actuators in a plug and play manner.

14. (canceled)

15. A context aware system comprising:
an asynchronous data store comprising a set of rules and definitions for interpreting the fact information received from the detectors;
a sensor mechanism comprising a plurality of detectors for detecting one or more parameters in an environment and outputting fact information relating to the one or more parameters;
a context mechanism including at least one reasoner for receiving the fact information from the plurality of detectors and transforming the fact information into situations based on a context of the fact information and situation definitions stored in the data store;
an adaptation mechanism for determining one or more reactions for at least one situation using a set of adaptation definitions stored in the data store;
a reactivity mechanism including a plurality of actuators for executing the one or more reactions;
wherein detectors and actuators are added to and removed from the system in a plug and play manner.

16. The system of claim 15, further comprising:
one or more context translators configured to translate the context into different formats that are compatible with different types of reasoners; and
a plurality of reasoners configured to output situations pertaining to different dimensions/domains, each reasoner being configured to operate independently on at least a portion of the fact information.

17. (canceled)

18. (Canceled)

19. A method for automatically controlling a plurality of actuators in a Context Aware System, the method comprising:
receiving fact information from a plurality of detectors;
extracting context from the fact information using a set of context definitions;
detecting one or more situations based on the context and a set of situation definitions;
selecting one or more reactions for at least one situation using a set of adaptation definitions and policy definitions; and
sending each reaction to an actuator for execution.

20. The method of claim 19, further comprising receiving the context definitions, situation definitions and policy definitions from a user and storing these in a data store.
